(19) United States
(12) Patent Application Publication
(10) Pub. No.: US 2017/0080269 A1
(43) Pub. Date: Mar. 23, 2017

(54) Fire Suppression Sprayer

(71) Applicant: Alan Zaia, Chicago, IL (US)

(72) Inventor: Alan Zaia, Chicago, IL (US)

(21) Appl. No.: 15/269,890

(22) Filed: Sep. 19, 2016

Related U.S. Application Data
(60) Provisional application No. 62/219,689, filed on Sep. 17, 2015.

(51) Int. Cl. A62C 17/00; A62C 13/00

(52) U.S. Cl. CPC A62C 17/00; A62C 13/003

(57) ABSTRACT

A fire suppression sprayer provides a top-mounted canister of fire suppression chemical, pressurize air, a spotlight, and laser to assist with aiming the sprayer and improves the accuracy of the release of the fire suppression chemical. The sprayer is patterned after a popular pressurized toy water pistol since the design is lightweight, and easy to learn how to use accurately.

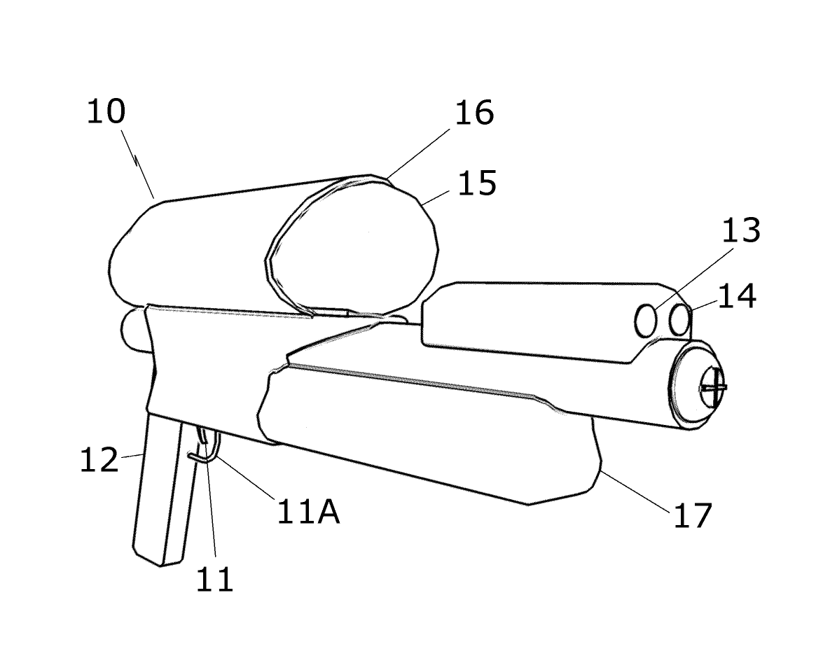

### CROSS-REFERENCE TO RELATED APPLICATIONS

This Application claims the benefit of U.S. Provisional Application No. 61/934,906, filed Feb. 3, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to firefighting equipment and in particular to a fire suppression sprayer. The traditional red cylindrical fire extinguisher has been updated with many other types of hand-held firefighting equipment. For several years, the fire suppression chemical Halon proved to be extremely effective when used in such devices. Unfortunately, the use of Halon has now been banned in many countries due to concerns about ozone depletion. Several other chemicals, notably HFC-227ea, were subsequently developed as non-ozone depleting fire suppression chemicals. However, these newer chemicals must be delivered with great precision to the source of the fire, since firefighters are unable to carry large amounts of any chemical. A gun design that incorporates pressurized air provides a solution, since the design is lightweight, already familiar to most people, and easy to learn how to use with a rewarding degree of accuracy. A fire suppression sprayer, which provides a top-mounted canister of fire suppression chemical, pressurize air, a spotlight, and laser to assist with aiming, would resolve this problem.

### SUMMARY OF THE INVENTION

Accordingly, the invention is directed to a fire suppression sprayer. The sprayer is patterned after a popular pressurized toy water pistol since the design is lightweight, and easy to learn how to use accurately. The sprayer provides a top-mounted canister of fire suppression chemical, pressurize air, a spotlight, and laser to assist with aiming the sprayer and improves the accuracy of the release of the fire suppression chemical.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

The FIGURE shows is a side perspective view of the first exemplary embodiment, displaying the sprayer 10, the trigger 11, the trigger guard 11A, the pistol grip 12, the spotlight 13, the laser 14, the canister 15, the socket 16, and the pressure pump handle 17.

### DETAILED DESCRIPTION OF THE INVENTION

Referring now to the invention in more detail, the invention is directed to a fire suppression sprayer 10.

The first exemplary embodiment is comprised of a hand-held sprayer 10 which is patterned after a popular pressurized toy water pistol, with a rear pistol grip 12 and trigger 11 intended to be operated by the user's dominant hand, and a pressure pump handle 17, similar to the pump handle on a shotgun, intended to be operated by the user's non-dominant hand. The trigger 11, trigger guard 11A, and pistol grip 12 are sized and contoured such that they may be easily operated while wearing bulky gloves. The design is lightweight, already familiar to most young people, and easy to learn how to use accurately.

The sprayer 10 provides a top mounted, quick-change canister 15 of fire suppressant chemical, which fits into a forward-facing socket 16, and a spotlight 13 and laser 14 to assist with aiming the sprayer 10. The forward-facing socket 16 is connected to a nozzle 18. The pressure pump handle 17 may be used to accumulate compressed air, which is used to propel the chemical from the canister 15, through the forward-facing socket 16, and out of the nozzle 18. The spotlight 13 and laser 14 are powered by the same rechargeable battery, and are activated by buttons which are preferably located on the side of the sprayer 10 above the pressure pump handle 17, on the nozzle 18 and intended for convenient operation by the index finger and middle finger of the user's non-dominant hand.

An alternate embodiment, providing a three-position rocker switch above the pistol grip 12, intended for operation by the thumb of the user's dominant hand, is contemplated. Other alternate embodiments, which replace the pressure pump handle 17 with an electric air pump powered by the same battery as the spotlight 13 and laser 14, are also contemplated.

Refillable replacement canisters 15 are available separately. Preferably, a bandolier manufactured from fireproof fabric is also available, which provides a plurality of canister pouches to enable rapid reloading of fresh canisters 15 while fighting a fire. A removable adapter and power cord are provided for the purpose of recharging the battery.

To use the first exemplary embodiment, the user grasps the pistol grip 12 with the dominant hand and the pressure pump handle 17 with the non-dominant hand. The user pressurizes the sprayer 10 by sliding the pressure pump handle 17 back, then forward several times, and may operate the spotlight 13 and laser 14 by pressing the activation buttons on the side of the sprayer 10. The user aims the sprayer 10 at the base of the flames and squeezes the trigger 11.

The sprayer 10, the pistol grip 12, and the pressure pump handle 17 are preferably manufactured from a rigid, durable material which is heat resistant and absorbs heat slowly, such as polytetrafluoroethylene. The trigger 11, the trigger guard 12, the spotlight 13, the laser 14, the canister 15, and the socket 16 are preferably manufactured from a rigid, durable material which is resistant to heat and corrosion, such as stainless steel or aluminum alloy, providing a spotlight lens which is preferably manufactured from a rigid, durable material which is heat resistant, transparent, and shatterproof, such as tempered glass.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A fire suppression sprayer, comprising:
a. a hand-held sprayer;
b. said hand-held sprayer having a rear pistol grip, a trigger, a pressure pump handle, a forward-facing socket, and a nozzle;
c. a top mounted canister containing a fire suppressant chemical;
d. said top mounted canister attaching to the forward-facing socket such that the fire suppressant chemical passes through the forward facing socket which is connected to the nozzle; and
e. said pressure pump generating and accumulating compressed air such that the fire suppressant chemical is propelled out of the nozzle when the trigger is squeezed.

2. The fire suppression sprayer of claim 1, further comprising a trigger guard; said trigger guard surrounding the trigger.

3. The fire suppression sprayer of claim 1, further comprising a spotlight and a laser; said spotlight and said laser being located on the side of the sprayer above the pressure pump on the nozzle.

4. The fire suppression sprayer of claim 2, further comprising a spotlight and a laser; said spotlight and said laser being located on the side of the sprayer above the pressure pump on the nozzle.

5. A fire suppression sprayer, comprising:
a. a hand-held sprayer;
b. said hand-held sprayer having a rear pistol grip, a trigger, an electric air pump, a forward-facing socket, and a nozzle;
c. a top mounted canister containing a fire suppressant chemical;
d. said top mounted canister attaching to the forward-facing socket such that the fire suppressant chemical passes through the forward facing socket which is connected to the nozzle; and
e. said electric air pump generating and accumulating compressed air such that the fire suppressant chemical is propelled out of the nozzle when the trigger is squeezed.

6. The fire suppression sprayer of claim 5, further comprising a three-position rocker switch; said three-position rocker switch being configured to control power to and activate the electric air pump.

7. The fire suppression sprayer of claim 5, further comprising a trigger guard; said trigger guard surrounding the trigger.

8. The fire suppression sprayer of claim 6, further comprising a trigger guard; said trigger guard surrounding the trigger.

9. The fire suppression sprayer of claim 5, further comprising a spotlight and a laser; said spotlight and said laser being located on the side of the sprayer above the pressure pump on the nozzle.

10. The fire suppression sprayer of claim 6, further comprising a spotlight and a laser; said spotlight and said laser being located on the side of the sprayer above the pressure pump on the nozzle.

11. The fire suppression sprayer of claim 7, further comprising a spotlight and a laser; said spotlight and said laser being located on the side of the sprayer above the pressure pump on the nozzle.

12. The fire suppression sprayer of claim 8, further comprising a spotlight and a laser; said spotlight and said laser being located on the side of the sprayer above the pressure pump on the nozzle.
